(19) United States
(12) Patent Application Publication
(10) Pub. No.: US 2014/0213942 A1
(43) Pub. Date: Jul. 31, 2014

(54) CARDIOPULMONARY RESUSCITATION DEVICE

(71) Applicant: Joseph Hanson, Milwaukee, WI (US)

(72) Inventor: Joseph Hanson, Milwaukee, WI (US)

(21) Appl. No.: 14/188,401

(22) PCT Filed: Aug. 25, 2011
(86) PCT No.: PCT/US2011/049157

§ 371 Date: Apr. 10, 2014

(51) Int. Cl. A61H 31/00

(52) U.S. Cl. CPC A61H 31/00
USPC 601/43

(57) ABSTRACT

A manual cardiopulmonary resuscitation device for delivering chest compressions to a patient needing CPR. The device includes a handle, a deformable housing having a first end and a second end, an aperture positioned near the first end of the deformable housing, and a gasket or cover connected to the second end of the deformable housing. The deformable housing is configured to deform when pressure is applied to the handle to thereby apply compressive pressure to the patient's chest.

### FIELD OF THE INVENTION

The present invention relates to a cardiopulmonary resuscitation (CPR) aid.

### BACKGROUND OF THE INVENTION

Cardiopulmonary resuscitation or CPR is a combination of rescue breathing (mouth-to-mouth resuscitation) and chest compressions. If a person is not breathing or circulating blood adequately, CPR can restore circulation of oxygen-rich blood to the brain and heart. CPR may be necessary during many different emergencies, including cardiac arrest, accidents, near-drowning, drug overdose, suffocation, poisoning, smoke inhalation, and electrocution injuries.

CPR involves administering a number of chest compressions, each at a specified rate and force, separated by moments of artificial respiration therebetween. When a user is performing CPR, accuracy in performing the task is important. The timing, number and force of each chest compression must be precisely executed to assure maximum effect of the procedure on the person. Furthermore, since providing CPR is usually done during times of duress, keeping track of the compressions, keeping an even rhythm, and maintaining a constant compression force can be difficult, especially for an untrained or newly certified user.

### SUMMARY OF THE INVENTION

In 2010, the American Heart Association and International Liaison Committee on Resuscitation updated their CPR guidelines. See Field, J. M., et al., “Part 1: executive summary: 2010 American Heart Association Guidelines for Cardiopulmonary Resuscitation and Emergency Cardiovascular Care,” Circulation 122 (18 Suppl 3): S640-56 (November 2010). The importance of high quality CPR (sufficient rate and depth without excessively ventilating) was emphasized and the experts agreed that it is important to reduce time to first chest compressions. Therefore, the order of interventions for basic life support was changed for all age groups except newborns from airway, breathing, chest compressions (ABC) to chest compressions, airway, breathing (CAB).

According to the updated CPR guidelines (Berg, Robert A. et al., “Part 5: Adult Basic Life Support: 2010 American Heart Association Guidelines for Cardiopulmonary Resuscitation and Emergency Cardiovascular Care,” Circulation 122 (18 Suppl 3): S685-S705 (November 2010), chest compressions consist of forceful rhythmic applications of pressure over the lower half of the sternum. These compressions create blood flow by increasing intrathoracic pressure and directly compressing the heart. This generates blood flow and oxygen delivery to the myocardium and brain. Effective chest compressions are essential for providing blood flow during CPR. For this reason, it is recommended that all patients in cardiac arrest should receive chest compressions.

To provide effective chest compressions, laypersons and healthcare providers need to push hard and push fast over the lower half of the sternum. It is reasonable for laypersons and healthcare providers to compress the adult chest at a rate of at least 100 compressions per minute with a compression depth of at least 2 inches/5 cm. Rescuers should allow complete recoil of the chest after each compression, to allow the heart to fill completely before the next compression.

Rescuers should attempt to minimize the frequency and duration of interruptions in compressions to maximize the number of compressions delivered per minute. A compression-ventilation ratio of 30:2 is recommended.

Once chest compressions have been started, a trained rescuer should deliver rescue breaths by mouth-to-mouth or bag-mask to provide oxygenation and ventilation, as follows:
1. Deliver each rescue breath over 1 second.
2. Give a sufficient tidal volume to produce visible chest rise.
3. Use a compression to ventilation ratio of 30 chest compressions to 2 ventilations.

The present invention is configured to provide a readily available hand held assist mechanism for “good samaritans” and first responders. By providing a simple disposable hand held assist product for CPR, it may improve bystanders' willingness to become a “good samaritan.”

The updated CPR guidelines recommend chest compressions at a rate of at least 100/minute. Studies have shown that higher compression rates are associated with higher survival rates. However, it is difficult for a layperson or first responder to apply rapid compressions at the recommended rate of 100/minute. Accordingly, the present invention provides an ergonomical device that makes is easier to accomplish the rapid compressions at the recommended rate.

The present invention relates to a device for assisting a layperson, rescuer, or healthcare provider in providing effective chest compressions as discussed above. In some exemplary embodiments, the invention provides a manual cardiopulmonary resuscitation device. The device includes a handle and a deformable housing having a first end and a second end. The first end is connected to the handle, and the first end includes a first perimeter and the second end includes a second perimeter, and the second perimeter is greater than the first perimeter. The device also includes a valve integral with the deformable housing, and a gasket connected to the second end of the deformable housing. The gasket includes a diaphragm thereby forming a chamber, and the deformable housing is configured to deform when pressure is applied to the handle.

In another exemplary embodiment, the invention provides a manual cardiopulmonary resuscitation device including a housing having a plurality of pleats. The housing defines a chamber having a first volume when the housing is in a first position and a second volume when the housing is in a second position. The device also includes a valve connected to the housing and is in fluid communication with the chamber, and a handle connected to the housing. The handle is configured to receive pressure to thereby move the housing from its first position to its second position to apply compression to a patient's chest.

In yet another exemplary embodiment, the invention provides a manual cardiopulmonary resuscitation device comprising a handle, a deformable housing, and a cover removably coupled to the deformable housing. The deformable housing includes a first portion coupled to the handle, a second portion having a first end and a second end, the first end connected to the first portion, and wherein the first end includes a first perimeter and the second end includes a second perimeter, and wherein the second perimeter is greater than the first perimeter. The deformable housing also includes an aperture formed within the second portion, and a third portion connected to the second portion and including a rim adjacent to the second end of the second portion and extending around a periphery of the second portion. The cover is removably coupled to the rim.

### BRIEF DESCRIPTION OF THE DRAWINGS

FIG. 1 is a perspective view of a cardiopulmonary resuscitation device according to one embodiment of the present invention.

FIG. 2 is a side view of the cardiopulmonary resuscitation device illustrated in FIG. 1.

FIG. 3 is a cross-sectional view of the cardiopulmonary resuscitation device illustrated in FIG. 1.

FIG. 4 is a top view of the cardiopulmonary resuscitation device illustrated in FIG. 1.

FIG. 5 is a perspective view of a cardiopulmonary resuscitation device according to one embodiment of the present invention.

FIG. 6 is a perspective view of a cardiopulmonary resuscitation device according to one embodiment of the present invention.

FIG. 7 is a cross-sectional view of the cardiopulmonary resuscitation device illustrated in FIG. 6.

FIG. 8 is an exploded view of the cardiopulmonary resuscitation device illustrated in FIG. 6.

FIG. 9 is an enlarged cross-sectional view of a portion of the cardiopulmonary resuscitation device illustrated in FIG. 6.

FIG. 10 is a schematic diagram of an electronics assembly used in any one of the cardiopulmonary resuscitation devices illustrated herein.

### DETAILED DESCRIPTION

It is to be understood that the invention is not limited in its application to the details of construction and the arrangements of the components set forth in the following description or embodiments, or illustrated in the drawings. The invention is capable of other embodiments and of being practiced or being carried out in various ways. Also, it is to be understood that the phraseology and terminology used herein is for the purpose of description and should not be regarded as limiting.

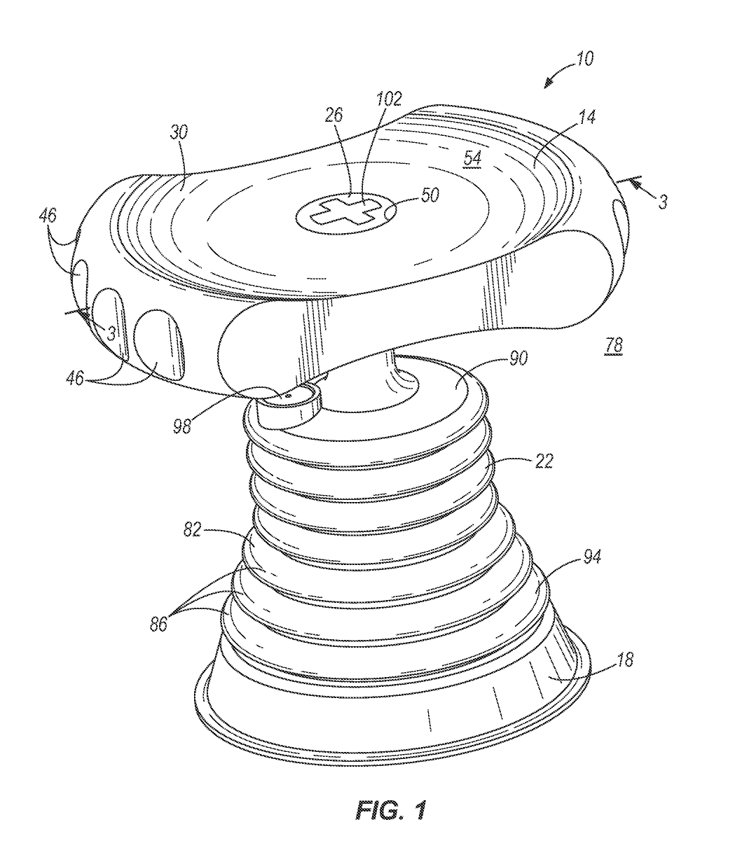

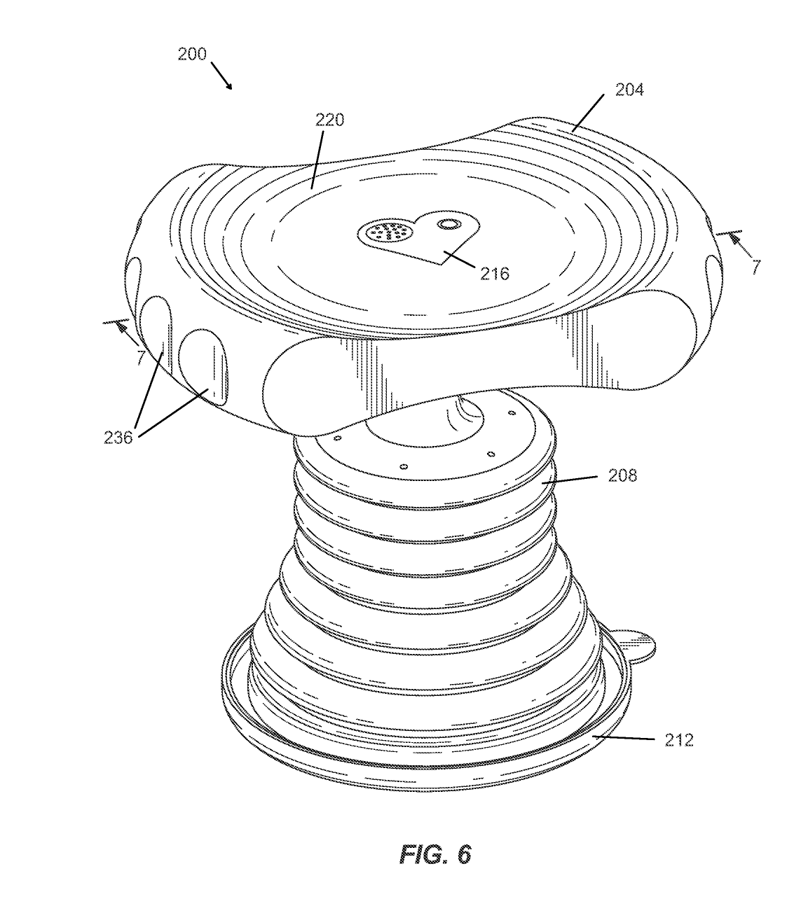

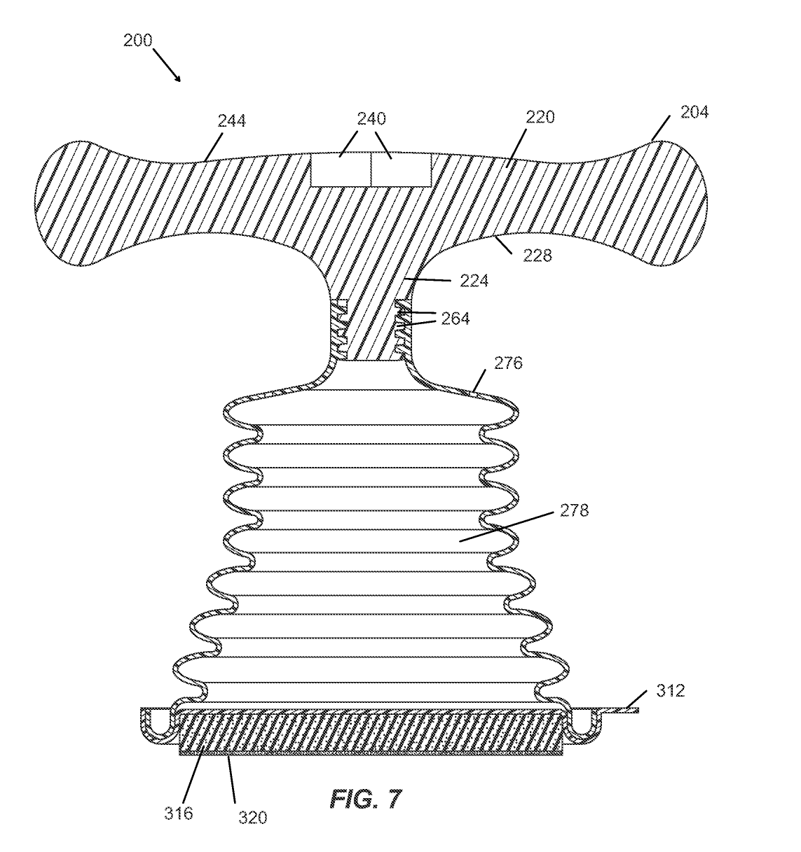

FIGS. 1-5 illustrate a cardiopulmonary resuscitation (CPR) device 10 according to one embodiment of the present invention. FIGS. 6-9 illustrate a CPR device 200 according to another embodiment of the present invention. The CPR devices 10, 200 are configured to aid a user while performing CPR on a patient. The devices 10, 200 are held by the user and placed on the patient's chest, at which time the user presses down onto the device 10, 200 repeatedly in short, quick strokes to perform chest compressions in accordance with CPR procedures. During use, the devices 10, 200 provide audio and/or visual feedback to the user in real-time regarding any one of the force, timing, and number of compressions administered to the patient. The devices 10, 200 may also modify (e.g., reduce) the force applied by the user so that the patient does not experience any potentially harmful forces.

In the illustrated construction of FIGS. 1-5, the device 10 includes a handle 14, a gasket 18 positionable on the patient's chest, and a deformable housing 22 extending between the gasket 18 and the handle 14 to transmit force therebetween. In some constructions, the device 10 also includes an electronics assembly 26 to provide visual and/or audio feedback to the user while he or she administers CPR.

Illustrated in FIGS. 1 and 3-5, the handle 14 of the CPR device 10 includes a body 30 having a periphery, and a protrusion 34 extending axially from a bottom surface 38 of the body 30 to produce a stepped end 42. When assembled, the stepped end 42 of the protrusion 34 is at least partially received within and coupled to one end of the deformable housing 22. During operation, the user grasps the handle 14, typically along its periphery, in such a way that allows the user to impart a vertical force into the device 10 and ultimately to the patient. Generally, the user leans or otherwise presses onto the handle 14 with both hands in a downward direction to apply compressive pressure to the patient's chest for each compression.

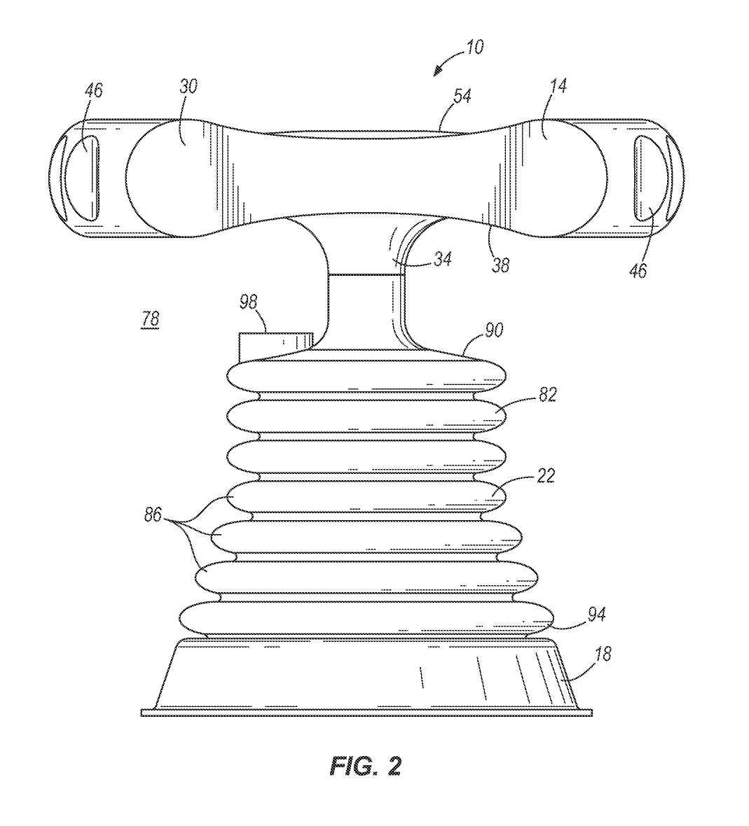

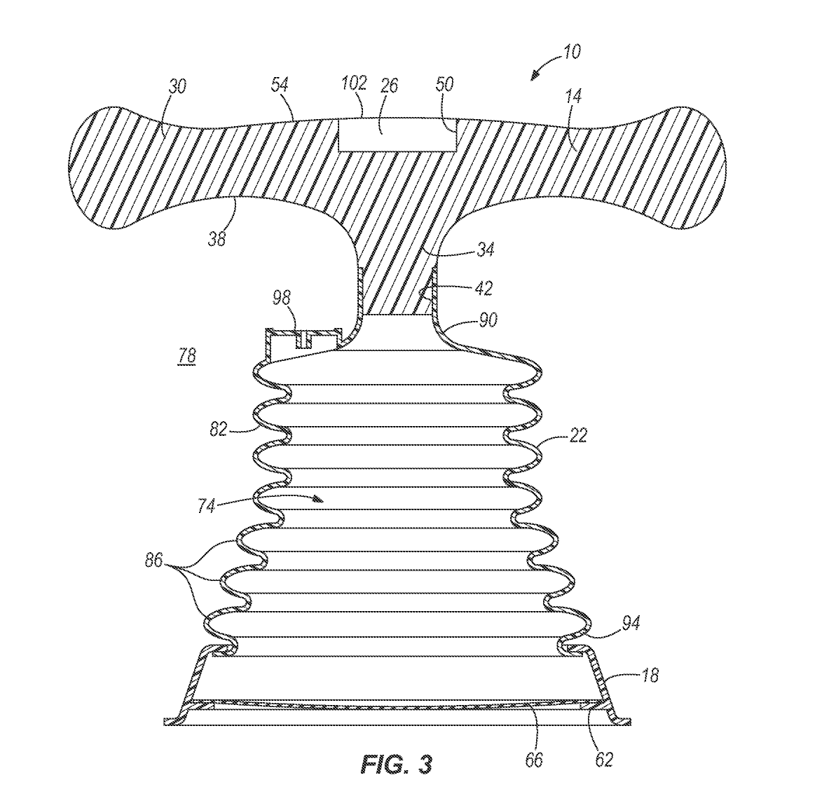

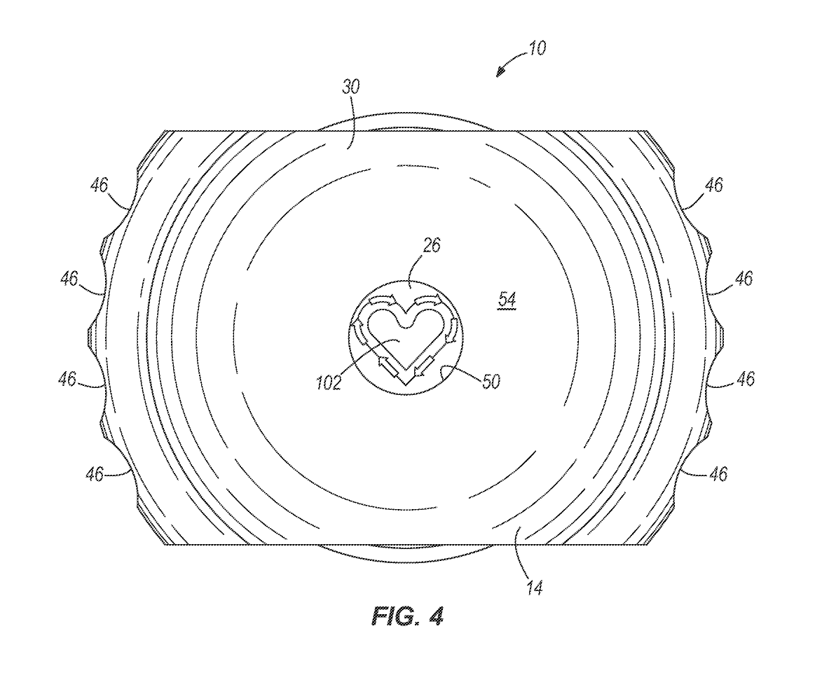

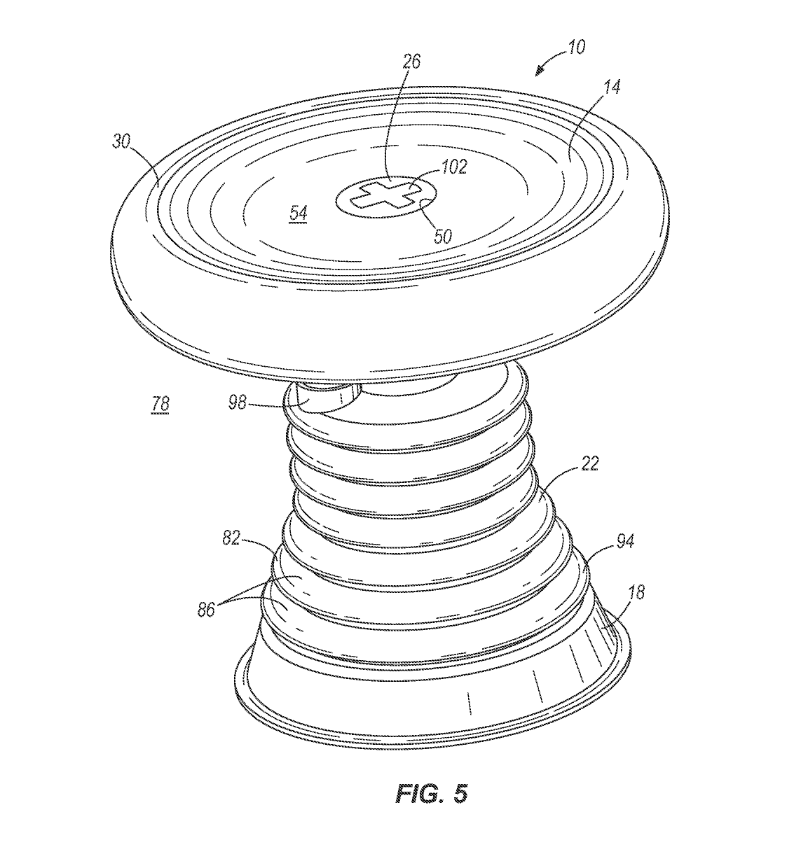

As best illustrated in FIGS. 2-3, the body 30 of the handle 14 is generally thickest along its periphery while gradually tapering as it extends radially inward. With reference to FIGS. 1-4, in some constructions, the handle 14 may also include a plurality of notches 46, each extending inwardly from the periphery of the handle 14 to correspond to one or more of the user's fingers. In other constructions, the handle 14 may also include pads or be coated in foam rubber or other suitable materials to help reduce hand fatigue and increase user comfort. Although the illustrated handle includes a pair of opposing linear walls and a pair of opposing curved walls (see FIG. 4), the body 30 of the handle 14 may also include a disk-like shape (see FIG. 5) or any other suitable contours that are ergonomically effective. The body 30 of the handle 14 also includes a recess 50 formed in a top surface 54 thereof to receive at least a portion of the electronics assembly 26.

Illustrated in FIGS. 1-3, the deformable housing 22 of the device 10 is somewhat conical in shape having an outer wall 82 that includes a plurality of pleats 86, a first end 90 having a first perimeter, and a second end 94 having a second perimeter larger than the first perimeter. When assembled, the handle 14 is attached to the first end 90 of the housing 22 and secured therein with a friction fit or with an adhesive, and the gasket 18 (with diaphragm 66) is coupled to the second end 94 of the housing 22, defining a chamber 74 therebetween (see FIG. 3).

Illustrated in FIGS. 2 and 3, the gasket 18 of the device 10 is formed from flexible material, such as rubber, and is configured to form a seal with and conform to the contours of the patient's chest. In alternative constructions, adhesive (e.g., medical grade) can be secured to the gasket 18 and to the patient's chest to stabilize the device 10 while performing the compressions. In the illustrated construction, the gasket 18 includes a side wall that is substantially annular in shape and flares radially outwardly to a base, which continues to extend radially outwardly from the side wall at an angle with respect to the side wall. The shape of the gasket 18 allows it to flex such that when it is pressed down on the patient's chest or torso, it conforms to the user's chest and forms a seal therewith. As such, the gasket 18 is able to maintain the device's location on the patient during the CPR process.

The gasket 18 also includes a lip 62 extending circumferentially around an inner perimeter of the gasket 18 and extending radially inwardly from an inner surface of the gasket 18 to provide a mounting location for a diaphragm 66, described below. The lip 62 can be formed or molded integrally with the gasket 18. In the illustrated construction, an upper portion of the gasket 18 curves radially inwardly from the side wall of the gasket and is configured to couple to the second end 94 of the deformable housing 22.

With further reference to FIG. 3, the diaphragm 66 is substantially disk-like, being formed of clear, somewhat flexible material. The diaphragm 66 is sealably coupled to the lip 62 of the gasket 18 to isolate the chamber 74 from the surroundings 78. In particular, an outer circumferential portion of the diaphragm 66 is sealably coupled to an upper surface of the lip 62. In the illustrated construction, the diaphragm 66 is able to flex or deform in response to changes in pressure in the chamber 74. The diaphragm 66 also allows the gasket 18 to seal or otherwise suction onto the user's chest during use.

The housing 22 also includes a valve 98 near the first end 90. The valve 98 is configured to control fluid communication between the chamber 74 and the surroundings 78. During operation, the valve 98 is adjustable between an open position, where the chamber 74 and the surroundings 78 are in fluid communication, and a closed position, where the chamber 74 and the surroundings 78 are not in fluid communication. In the illustrated construction, the valve 98 is actuateable between the open and closed positions based at least partially upon the pressure differential between the chamber 74 and the surroundings 78. Stated differently, when the pressure within the chamber 74 exceeds the pressure of the surroundings 78 by a predetermined threshold, the valve 98 opens allowing air to leave the chamber 74.

Although the valve 98 is integrally formed with the housing 22 in the illustrated construction, in alternate constructions, the valve may be formed separately. In still other constructions, the valve 98 may be positioned in or formed integrally with any one of the handle 14, the diaphragm 66, and the like.

The CPR device 10 is assembled as a unit. An order of assembly is not intended by this description. The diaphragm 66 is sealably coupled to the lip 62 of the gasket 18. The top of the gasket 18 is coupled to the second end 94 of the housing 22. The stepped end 42 of the handle 14 is coupled to the first end 90 of the housing 22, and the electronics assembly 26 is at least partially received within the recess 50 of the handle 14. If the valve 98 is not integrally formed with the housing 22, it may also be installed as necessary.

FIGS. 6-9 illustrate a cardiopulmonary resuscitation device 200 according to an embodiment of the present invention. The device 200 includes a handle 204, a deformable housing 208 connectable to and extending from the handle 204, and a cover 212 removably coupled to the deformable housing 208. In some constructions, the device 200 also includes an electronics assembly 216 to provide visual and/or audio feedback to the user while he or she administers CPR.

The handle 204 includes a body 220 having a periphery, and a protrusion 224 extending axially from a bottom surface 228 of the body 220. The protrusion 224 includes threads 232 at a distal end thereof to be threadably coupled to the deformable housing 208. As illustrated, the threads 232 are on an outer surface of the protrusion 224 such that the protrusion is received by the deformable housing 208 when coupled together. During operation, the user grasps the handle 204, typically along its periphery, in such a way that allows the user to impart a vertical force into the device 200 and ultimately to the patient. Generally, the user leans or otherwise presses onto the handle 204 with both hands in a downward direction to apply compressive pressure to the patient's chest for each compression.

The body 220 of the handle 204 is generally thickest along its periphery while gradually tapering as it extends radially inward. As illustrated, the handle 204 may also include a plurality of notches 236, each extending inwardly from the periphery of the handle 204 to correspond to one or more of the user's fingers. In other constructions, the handle 204 may also include pads or be coated in foam rubber or other suitable materials to help reduce hand fatigue and increase user comfort. The body 220 of the handle 204 also includes a recess 240 formed in a top surface 244 thereof to receive at least a portion of the electronics assembly 216.

The deformable housing 208 of the device 200 is somewhat conical in shape and includes a first portion 248, a second portion 252 having a plurality of pleats 256, and a third portion 260. The first portion 248 or neck includes an outer perimeter small than an outer perimeter of the second portion 252 and the third portion 260. The first portion 248 includes an inner surface having a plurality of threads 264 for mating with the threads 232 of the handle 204. Other suitable methods of coupling the handle 204 to the first portion 248 also are contemplated by the invention. The first portion 248 is integral with and gradually tapers into the second portion 252.

The second portion 252 includes a first end 268 having a first perimeter and a second end 272 having a second perimeter larger than the first perimeter. The plurality of pleats 256 are arranged between the first end 268 and the second end 272. The second portion 252 also includes one or more apertures 276 arranged in one of the first pleats at the first end 268. The apertures 276 extend through the thickness of the wall of the pleat 256 and provide fluid communication between a chamber 278 and the atmosphere.

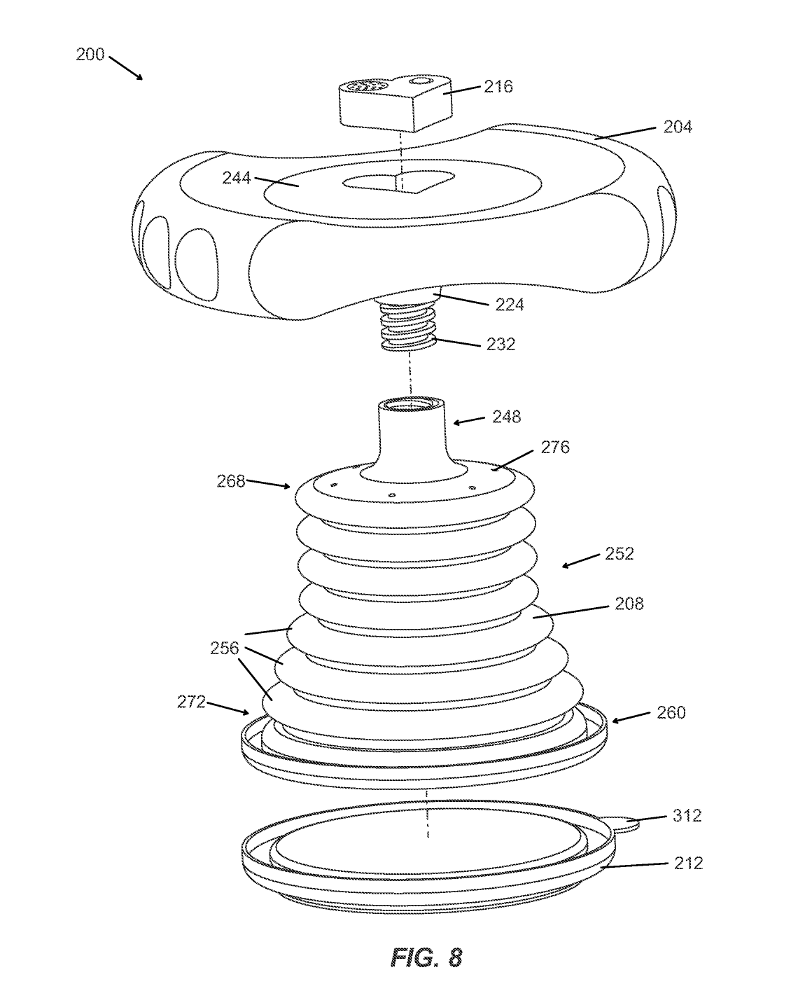

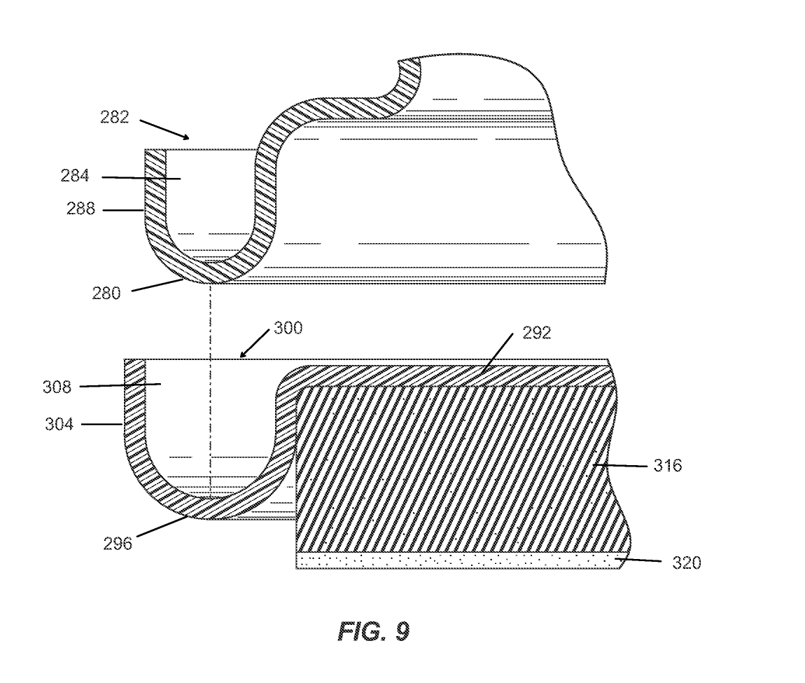

With reference to FIGS. 8-9, the third portion 260 is integral with the second portion 252 and has an upturned sidewall that forms a rim 280. The rim 280 is adjacent to the second end 272 of the second portion 252 and extends around the periphery of the second portion 252. The rim 280 defines a channel 282 that includes an inner surface 284 and an outer surface 288.

The cover 212 is removably coupled to the rim 280 thereby allowing the cover 212 to be disposable, and the remainder of the device 200 is reusable. The cover 212 includes a generally planar base 292, which is configured and sized to fit within the dimensions defined by the second end 272 of the second portion 252. The cover 212 includes a ridge 296 extending around the perimeter of the base 292. The ridge 296 defines a groove 300 on an underside thereof and includes an outer surface 304 and an inner surface 308. The ridge 296 is configured to receive the rim 280 such that the inner surface 308 of the groove 300 mates with the outer surface 288 of the channel 280. The cover 212 includes a tab 312 extending laterally from an edge of the ridge 296 for removing the cover 212 from the third portion 260 of the deformable housing 208. The cover 212 includes a foam insert 316 coupled to the base 292 and an adhesive layer 320 coupled to the foam insert 316.

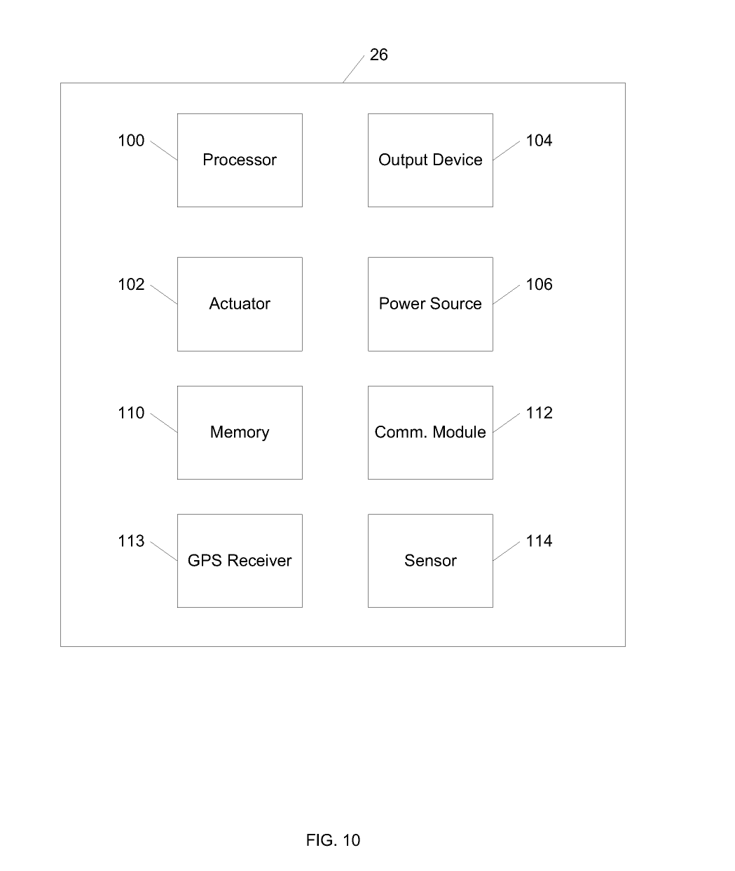

As illustrated in FIG. 10, the electronics assembly 26, 216 includes a processor 100 (e.g., a microprocessor, a microcontroller, or another suitable programmable device), one or more output devices 104 (e.g., a speaker and/or an illumination device) in electrical communication with the processor 100, an actuator 102 to activate the electronics, and a power source 106 (e.g., a battery). The electronics assembly 26, 216 can also include memory 110 for storing data and or program instructions for execution by the processor 100. The memory 110 includes, for example, a read-only memory (“ROM”), a random access memory (“RAM”), an electrically erasable programmable read-only memory (“EEPROM”), a flash memory, a hard disk, an SD card, or another suitable magnetic, optical, physical, or electronic memory device. The processor 100 is connected to the memory 110 and executes software that is capable of being stored in the RAM (e.g., during execution), the ROM (e.g., on a generally permanent basis), or another non-transitory computer readable medium such as another memory or a disc. Additionally or alternatively, the memory 110 is included in the processor 100. Software included in the implementation of the device 10, 200 is stored in the memory 110 of the processor 110. The software includes, for example, firmware, one or more applications, program data, one or more program modules, and other executable instructions. The processor 100 is configured to retrieve from memory and execute, among other things, instructions related to the methods described below.

In some implementations, the electronics assembly 26, 216 is also configured to connect to a network (e.g., a WAN, a LAN, or the like) via a communications module 112 to access other programs, software, or systems. The communications module 112 can include a network interface, such as an Ethernet card or a wireless network card, that allows the electronics assembly 26, 216 to send and receive information over a network, such as a local area network or the Internet. Data communications can occur via a wireless local area network (“LAN”) using any of a variety of communications protocols, such as Wi-Fi, Bluetooth, ZigBee, or the like. Additionally or alternatively, data communications can occur over a wide area network (“WAN”) (e.g., a TCP/IP based network or the like).

The device 10, 200 can include a global positioning system (GPS) receiver 113 to indicate the device's location. The location information can be transmitted via the communications module 112 to local 911 call centers as an automated mode of communication to emergency personnel. This can be beneficial if other modes of communication are unavailable at the time or location.

The device 10, 200 can include one or more sensors 114 configured to detect force applied to the device, the number of compressions applied to the patient, the time between each compression, and other data. The data collected by the sensors 114 can be stored in the memory 110 and retrieved or downloaded at a later time. The data can be retrieved by hardwire connection to the electronics assembly 26, 216 or wirelessly over a network (described above). In the illustrated construction, the electronics assembly 26, 216 is substantially self-contained, being supported in a housing that includes the actuator 102. In alternate constructions, the electronics assembly 26, 216 may be positioned within the housing 22, 204, or spread out, such that different elements are contained within different aspects of the device 10, 200.

During operation, the housing 22, 208 is adjustable between a first position, where the chamber 74, 278 defines a first volume, and a second position, where the chamber 74, 278 defines a second, smaller volume. More specifically, in the illustrated constructions, the first end 90, 268 of the housing 22, 208 is adjustable axially with respect to the second end 94, 272 by collapsing and expanding the pleats 86, 256, thereby altering the volume defined by the chamber 74, 278. Generally speaking, the volume of the chamber 74, 278 shrinks as the first end 90, 268 approaches the second end 94, 272. In the illustrated constructions, the natural elasticity of the deformable housing 22, 208 biases the housing 22, 208 towards the first position. In alternate constructions, a spring (not shown) or other forms of actuation may be present to bias the deformable housing 22, 208 towards the first position.

During use, the user presses or otherwise activates the actuator 102, causing the processor 100 to transmit a signal to the output device(s) 104. For example, the processor 100 can transmit a signal to a speaker to output an audible signal (such as a series of tones from the speaker) and/or transmit a signal to an illumination device (e.g., LED) to output a visible signal (such as a series of flashes from the LED), at a regular, predetermined interval of time. The predetermined interval of time can be about 0.6 sec or 100 cycles per minute. In some constructions, the interval at which the signal is transmitted may be adjustable. In still other constructions, the processor 100 may also count the number of signals output without the application of pressure to the device such that the processor 100 can automatically turn off to preserve the power source 106.

If a patient goes into cardiac arrest or other emergency situation requiring CPR, the user may utilize the device 10, 200 in the following manner while administering CPR. If device 10 is utilized, the user positions himself next to the patient, then positions the device 10 so that the bottom of the gasket 18 is in contact with the patient's chest, forming a seal therewith, grasps the handle 14 of the device 10 with both hands, and activates the electronics assembly 26 by actuating the actuator 102. If device 200 is utilized, the user positions himself next to the patient, then peels off a backing of the adhesive layer 320 and positions the device 200 on the patient's chest, forming a seal therewith, grasps the handle 204 with both hands, and activates the electronics assembly 216 by actuating the actuator 102.

Once the electronics assembly 26, 216 is activated, the user must press down onto the handle 14, 204 in a quick, downward motion each time the electronics assembly 26, 216 outputs a signal (e.g., flashes a light and/or emits a tone). As the user presses down onto the handle 14, 204, the force provided by the user transmits through the handle 14, 204 and into the first end 90, 268 of the housing 22, 208. The applied force causes the first end 90, 268 of the housing 22, 208, which is naturally in the first position, to begin moving towards the second end 94, 272 of the housing 22, 208, causing the volume within the chamber 74, 278 to decrease and the pressure to increase. The increase in pressure acts onto the gasket 18 or foam insert 316 which in turn transmits the force into the patient, causing the chest compression to take place.

If the user presses down harder on the handle 14, 204 the pressure inside the chamber 74, 278 increases with respect to the surroundings 78 or atmosphere and the force applied to the patient increases. If the user presses down hard enough, the pressure in the chamber 74, 278 will exceed the pressure of the surroundings 78 or atmosphere by an amount greater than the predetermined threshold, causing the valve 98 or apertures 276 to open and allowing air to begin escaping the chamber 74, 278. As the air escapes, the pressure within the chamber 74, 278 remains constant and will not increase any further. As such, the force experienced by the patient will remain constant and cannot increase as well.

After the compression is complete, the user stops pressing onto the handle 14, 204, allowing the first end 90, 268 of the deformable housing 22, 208 to return to the first position and the pressure within the chamber 74, 278 to return to normal. The user then waits until another signal is produced from the electronics assembly 26, 216, at which time they will repeat the above described compression process.

Various features and advantages of the invention are set forth in the following claims.

What is claimed is:

1. A manual cardiopulmonary resuscitation device comprising:
a handle;
a deformable housing having a first end and a second end, the first end connected to the handle, and wherein the first end includes a first perimeter and the second end includes a second perimeter, and wherein the second perimeter is greater than the first perimeter;
a valve integral with the deformable housing; and
a gasket connected to the second end of the deformable housing, the gasket including a diaphragm thereby forming a chamber, the deformable housing configured to deform when pressure is applied to the handle.

2. The manual cardiopulmonary resuscitation device of claim 1 wherein the gasket is configured to interface with a patient's chest, and wherein the chamber includes a volume of air, and further wherein the volume of air in the chamber decreases as pressure is applied to the handle with the gasket in contact with the patient's chest.

3. The manual cardiopulmonary resuscitation device of claim 2 wherein the valve is configured to open when a predetermined amount of pressure is applied to the handle and thereby allowing the deformable housing to deform as the air in the chamber exits the valve.

4. The manual cardiopulmonary resuscitation device of claim 1 further comprising an electronics assembly supported by the handle, the electronics assembly including a processor, a speaker, an illumination device, and an actuator.

5. The manual cardiopulmonary resuscitation device of claim 4 wherein the speaker is in electrical communication with the processor such that when the actuator is activated, the speaker transmits an audible signal at a predetermined interval of time.

6. The manual cardiopulmonary resuscitation device of claim 5 wherein the illumination device is in communication with the processor such that when the actuator is activated, the illumination device transmits a visual indicator at the predetermined interval of time.

7. The manual cardiopulmonary resuscitation device of claim 1 further comprising an electronics assembly supported by the handle, the electronics assembly including a processor, a speaker, and an actuator.

8. The manual cardiopulmonary resuscitation device of claim 7 wherein the speaker is in electrical communication with the processor such that when the actuator is activated, the speaker transmits an audible signal at a predetermined interval of time.

9. The manual cardiopulmonary resuscitation device of claim 1 further comprising an electronics assembly supported by the handle, the electronics assembly including a processor, an illumination device, and an actuator.

10. The manual cardiopulmonary resuscitation device of claim 9 wherein the illumination device is in communication with the processor such that when the actuator is activated, the illumination device transmits a visual indicator at a predetermined interval of time.

11. The manual cardiopulmonary resuscitation device of claim 1 wherein the handle includes a third perimeter that is greater than the second perimeter.

12. The manual cardiopulmonary resuscitation device of claim 1 wherein the gasket is flexible and thereby configured to provide a seal with a patient's chest.

13. The manual cardiopulmonary resuscitation device of claim 1 wherein the deformable housing includes a plurality of pleats.

14. A manual cardiopulmonary resuscitation device comprising:
a housing including a plurality of pleats, the housing defining a chamber having a first volume when the housing is in a first position and a second volume when the housing is in a second position;
a valve connected to the housing and in fluid communication with the chamber; and
a handle connected to the housing, the handle configured to receive pressure to thereby move the housing from its first position to its second position to apply compression to a patient's chest.

15. The manual cardiopulmonary resuscitation device of claim 14 further comprising an electronics assembly supported by the handle, the electronics assembly including a processor, a speaker, an illumination device, and an actuator.

16. The manual cardiopulmonary resuscitation device of claim 15 wherein the speaker is in electrical communication with the processor such that when the actuator is activated, the speaker transmits an audible signal at a predetermined interval of time.

17. The manual cardiopulmonary resuscitation device of claim 16 wherein the illumination device is in communication with the processor such that when the actuator is activated, the illumination device transmits a visual indicator at the predetermined interval of time.

18. The manual cardiopulmonary resuscitation device of claim 14 further comprising an electronics assembly supported by the handle, the electronics assembly including a processor, a speaker, and an actuator.

19. The manual cardiopulmonary resuscitation device of claim 18 wherein the speaker is in electrical communication with the processor such that when the actuator is activated, the speaker transmits an audible signal at a predetermined interval of time.

20. The manual cardiopulmonary resuscitation device of claim 14 further comprising an electronics assembly supported by the handle, the electronics assembly including a processor, an illumination device, and an actuator.

21. The manual cardiopulmonary resuscitation device of claim 20 wherein the illumination device is in communication with the processor such that when the actuator is activated, the illumination device transmits a visual indicator at a predetermined interval of time.

22. A manual cardiopulmonary resuscitation device comprising:
a handle;
a deformable housing including
a first portion coupled to the handle,
a second portion having a first end and a second end, the first end connected to the first portion, and wherein the first end includes a first perimeter and the second end includes a second perimeter, and wherein the second perimeter is greater than the first perimeter,
an aperture formed within the second portion, and
a third portion connected to the second portion and including a rim adjacent to the second end of the second portion and extending around a periphery of the second portion; and
a cover removably coupled to the rim.

23. The manual cardiopulmonary resuscitation device of claim 22 wherein the rim defines a channel having an inner surface and an outer surface.

24. The manual cardiopulmonary resuscitation device of claim 23 wherein the cover includes a base configured to fit within the second end of the second portion.

25. The manual cardiopulmonary resuscitation device of claim 24 wherein the cover includes a ridge extending around the base.

26. The manual cardiopulmonary resuscitation device of claim 25 wherein the ridge defines a groove and includes an outer surface and an inner surface.

27. The manual cardiopulmonary resuscitation device of claim 26 wherein the ridge is configured to receive the rim.

28. The manual cardiopulmonary resuscitation device of claim 27 wherein the inner surface of the groove mates with the outer surface of the channel.

29. The manual cardiopulmonary resuscitation device of claim 28 wherein the cover includes a foam insert coupled to the base and an adhesive layer coupled to the foam insert.

30. The manual cardiopulmonary resuscitation device of claim 25 wherein the cover includes a tab extending laterally from an edge of the ridge for removing the cover from the third portion of the deformable housing.

31. The manual cardiopulmonary resuscitation device of claim 22 wherein the cover includes a foam insert coupled thereto and an adhesive layer coupled to the foam insert.

32. The manual cardiopulmonary resuscitation device of claim 22 further comprising an electronics assembly supported by the handle, the electronics assembly including a processor, a speaker, and an actuator.

33. The manual cardiopulmonary resuscitation device of claim 32 wherein the speaker is in electrical communication with the processor such that when the actuator is activated, the speaker transmits an audible signal at a predetermined interval of time.

34. The manual cardiopulmonary resuscitation device of claim 22 further comprising an electronics assembly supported by the handle, the electronics assembly including a processor, an illumination device, and an actuator.

35. The manual cardiopulmonary resuscitation device of claim 34 wherein the illumination device is in communication with the processor such that when the actuator is activated, the illumination device transmits a visual indicator at a predetermined interval of time.
